(19) United States
(12) Patent Application Publication
(10) Pub. No.: US 2009/0088672 A1
(43) Pub. Date: Apr. 2, 2009

(54) INTERCHANGEABLE BACK SCRATCHING DEVICE

(76) Inventors: Thomas A. VAUGHAN, Farmville, VA (US); Robert W. Strauch, SR., Rice, VA (US); Marie A. Strauch, Rice, VA (US)

Correspondence Address: Kimberly A. Chasteen, PO Box 1243, Yorktown, VA, 23692, US

(21) Appl. No.: 12/240,631

(22) Filed: Sep. 29, 2008

Related U.S. Application Data
(60) Provisional application No. 60/995,898, filed on Sep. 29, 2007.

(51) Int. Cl. A61H 7/00; A46B 9/02

(52) U.S. Cl. 601/136; 15/160

(57) ABSTRACT

A back scratching device for mounting on a corner which includes a mounting element and a scratching element. The mounting element is mounted on the wall while the scratching element is releasable attached to the mounting element. The external surface of the scratching element is a material appropriate for scratching the user's back.

The present application claims priority from U.S. Provisional Application Ser. No. 60/995,898, filed Sep. 29, 2007.

### BACKGROUND OF THE INVENTION

1. Field of the Invention

This invention is directed to the field of back scratching devices, more particularly to a back scratcher with interchangeable scratching surfaces.

2. Description of Related Art

The present invention relates to an improved back scratching device that features interchangeable scratching surfaces and which is mounted such that it does not need to be held by the user.

Currently, most back scratching devices are hand held. Alternatively, some people use the bare corner of a wall for back scratching purposes. Those who have handicaps in the hands, arms and/or shoulders or limited range of motion cannot effectively reach around to scratch their back. Even able-bodied people can benefit from this invention.

A further benefit of this invention is the interchangeability of the scratching surface. This allows the user to choose the type of surface used for the desired amount of scratching to be provided.

While there are numerous prior devices known for assisting in scratching a user's back, none offer the ease or accuracy necessary for accomplishing the task, particularly for those with limited range of motion. The manner by which the present invention achieves the goals hereof will become more apparent in the description which follows, especially when read in conjunction with the accompanying drawings.

An object of the present invention is to provide a back scratching device which is not hand held.

An object of the present invention is to provide a back scratching device which is quickly and easily mounted for use.

Yet another object of the present invention is to provide a back scratching device which provides interchangeable scratching surfaces.

Finally, it is an object of the present invention to accomplish the foregoing objectives in a simple and cost effective manner.

### SUMMARY OF THE INVENTION

The present invention addresses these objects by providing a back scratching device for mounting to a corner of a wall. The device includes a mounting element which has an internal

### BRIEF DESCRIPTION OF THE DRAWINGS

A more complete description of the subject matter of the present invention and the advantages thereof, can be achieved by the reference to the following detailed description by which reference is made to the accompanying drawings in which:

FIG. 1 is a view of the external surface of the mounting element of the preferred embodiment of the present invention;

FIG. 2 is a view of the internal surface of the mounting element of the preferred embodiment of the present invention;

FIG. 3 is a view of the external surface of the scratching element of the preferred embodiment of the present invention;

FIG. 4 is a view of the internal surface of the scratching element of the preferred embodiment of the present invention; and

FIGS. 5a-5c are top views of the scratching element of the preferred embodiment of the present invention showing alternate embodiments of the scratching surface.

### ELEMENT LIST

12 optional mounting hole
14 releasable mounting medium
16 external surface of mounting element
18 optional adhesive
20 internal surface of mounting element
22 abrasive or scratching surface
24 seam
26 external surface of scratching element
28 releasable mounting medium (mates with 14)
30 internal surface of scratching element
32 abrasive material
34 flexible tipped bristles
36 straight bristles

### DETAILED DESCRIPTION OF THE PREFERRED EMBODIMENT

The following detailed description is of the best presently contemplated mode of carrying out the invention. This description is not to be taken in a limiting sense, but is made merely for the purpose of illustrating general principles of embodiments of the invention.

The instant invention relates to a device to be mounted on a corner which effectively provides easily interchangeable scratching surfaces, depending on one's need. This invention allows an individual to scratch those hard to reach areas of their back without the use of hands, arms or shoulders, and is particularly useful to those with limited mobility. This invention, obviously, would assist anyone in scratching that hard to reach itch on his back, but would be most beneficial to the handicapped and elderly who lack the flexibility and movement/reaching ability required with the old and familiar hand-held back scratchers. This invention can be used both in the home as well as hotels, hospitals and other wellness and rehab centers.

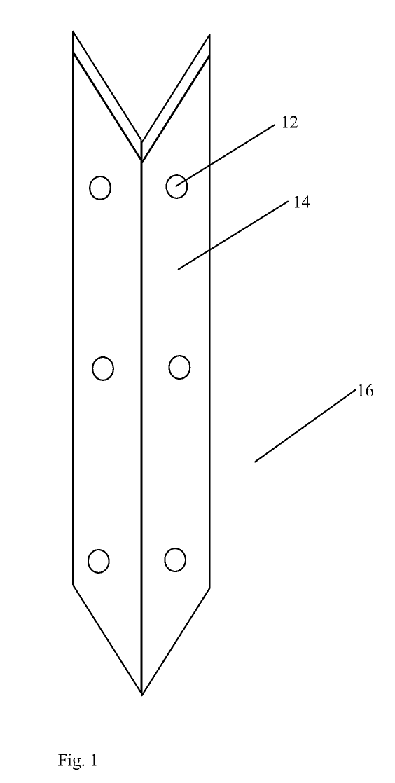

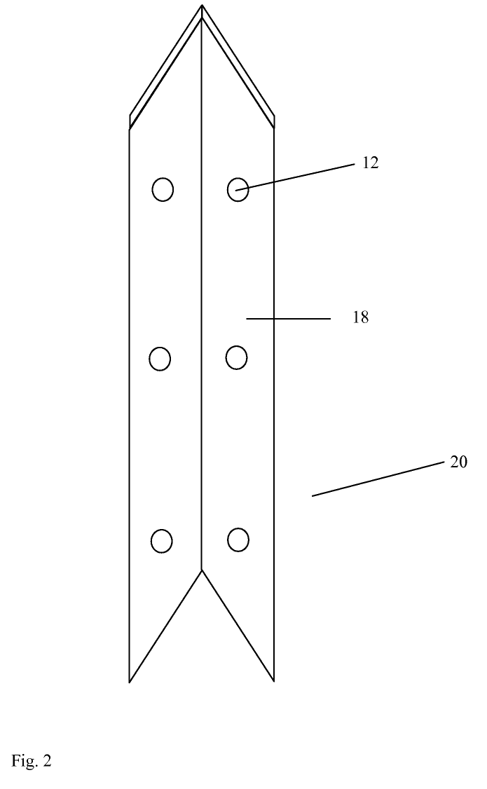

Turning now to the several Figures, where FIGS. 1 and 2 illustrate the mounting element of a back scratching device according to the present invention. FIG. 1 shows the external surface 16 of the mounting element of the device while FIG. 2 shows the internal surface 20 of the mounting element. The internal surface 20 includes a method for attaching the mounting element to a corner. Such method may be mounting holes 12, adhesive 18 or other means appropriate for mounting an item to a vertical surface. The external surface 16 includes a releasable mounting means 14 such as Velcro®. In its preferred embodiment, the mounting element of the invention is approximately 22 inches in length, ⅛ inch thick and extends approximately 1-1½ inches from the center corner on each side. The mounting element is constructed from a semi-flexible rubber or plastic, and the internal surface 20 includes a commercial glue 18 covered by a protective tape on its underside. The element portion is designed to fit over the corner of a wall, with the extensions situated at approximately a 90-degree angle. In addition or as an alternative to the commercial glue 18, the mounting element may include several holes 12 which allow mounting to be achieved by nails or screws.

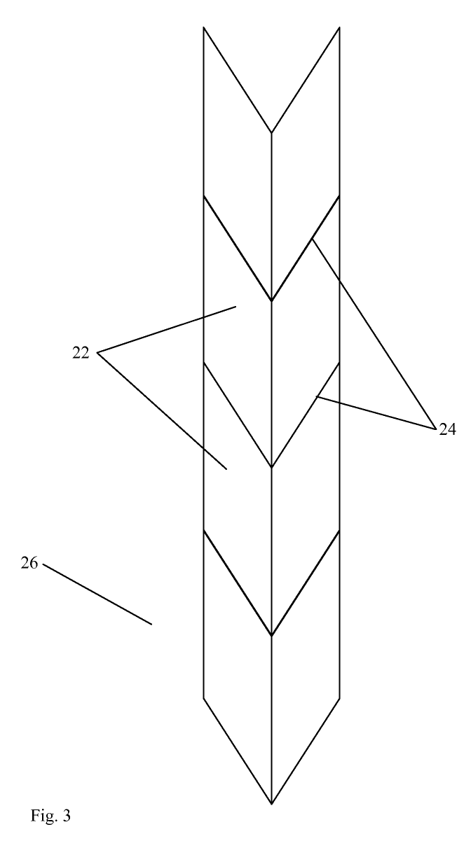

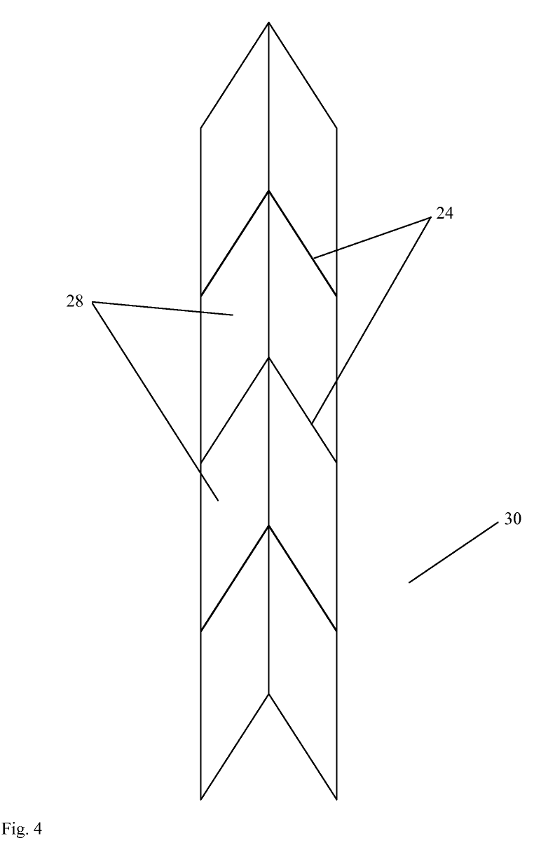

FIGS. 3-5 show the scratching element of the present invention. FIG. 3 shows the external surface 26 of the scratching element of the device while FIG. 4 shows the internal surface 30 of the scratching element. The internal surface 30 includes a releasable mounting means 28 which mates with the releasable mounting means 14 located on the external surface 16 of the mounting element. The external surface 26 includes scratching material such as an abrasive material 32, flexible tipped bristles 34, straight bristles 36 or any material appropriate for scratching a user's skin. In its preferred embodiment, the scratching element of the invention is approximately 22 inches in length, ⅛ inch thick and extends slightly further than the mounting element or approximately 1⅛-1⅝ inches from the center corner on each side. The scratching element is constructed from a semi-flexible rubber or plastic, and, in a particularly preferred embodiment, the scratching element includes seams 24 to facilitate removal from and attachment to the external surface 16 of the mounting element. The internal surface 30 of the scratching element includes a releasable mounting means 28, such as Velcro®, which mates with the releasable mounting means 14 located on the external surface 16 of the mounting element. The scratching element is designed to fit over the external surface 16 of the mounting element of the invention, with the extensions situated at approximately a 90-degree angle.

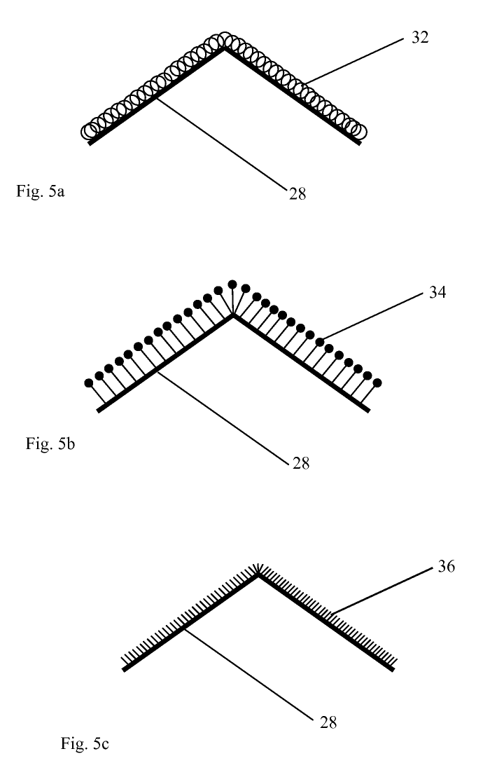

Several different interchangeable scratching elements are preferably provided with alternate external surfaces 26. For example, as shown in FIGS. 5a through 5c, the external surface 26 may be a simple rough surface 32 which is similar to a scrubbing pad, or a more formidable scratching surface with raised bristles, soft 34 or firm 36, as in a hair brush or wire bristles. Any surface appropriate for scratching a user's skin can be used as well.

Obviously, many modifications may be made without departing from the basic spirit of the present invention. Accordingly, it will be appreciated by those skilled in the art that within the scope of the appended claims, the inventions may be practiced other than has been specifically described herein. Many improvements, modifications, and additions will be apparent to the skilled artisan without departing from the spirit and scope of the present invention as described herein and defined in the following claims.

What is claimed is:

1. A back scratching device for mounting to a corner of a wall, comprising:
a mounting element having an internal surface and an external surface wherein the internal surface includes a mounting apparatus for attaching the mounting element to a corner of a wall and the external surface includes a releasable attachment means;
a scratching element having an internal surface and an external surface wherein the internal surface includes a releasable attachment means for connection the scratching element to the mounting element and wherein the external surface includes a scratching material appropriate for scratching a user's back.

2. The back scratching device as set forth in claim 1 wherein the mounting apparatus is selected from the group consisting of adhesive, glue and mounting holes which accept screws or nails.

3. The back scratching device as set forth in claim 1 wherein the releasable attachment means on the external surface of the mounting element is hook and loop fastener.

4. The back scratching device as set forth in claim 1 wherein the releasable attachment means on the internal surface of scratching element is hook and loop fastener.

5. The back scratching device as set forth in claim 1 wherein the scratching material is selected from the group consisting of abrasive material, straight bristles and flexible bristles.
